(19) United States
(12) Patent Application Publication
(10) Pub. No.: US 2018/0351656 A1
(43) Pub. Date: Dec. 6, 2018

(54) METHODS, SYSTEMS, AND DEVICES FOR HIGH THROUGHPUT ACOUSTIC TRANSMISSION

(71) Applicants: Chengzhi Shi, El Cerrito, CA (US); Yuan Wang, Albany, CA (US); Xiang Zhang, Alamo, CA (US)

(72) Inventors: Chengzhi Shi, El Cerrito, CA (US); Yuan Wang, Albany, CA (US); Xiang Zhang, Alamo, CA (US)

(73) Assignee: The Regents of the University of California, Oakland, CA (US)

(21) Appl. No.: 15/996,207

(22) Filed: Jun. 1, 2018

Related U.S. Application Data
(60) Provisional application No. 62/513,750, filed on Jun. 1, 2017.

(51) Int. Cl. H04B 11/00; G10K 11/34

(52) U.S. Cl. CPC H04B 11/00; G10K 11/34

(57) ABSTRACT

Disclosed herein are methods, systems, and devices for acoustic transmission and reception. Disclosed herein are methods, systems, and devices for acoustic transmission and reception. Methods may include receiving, at a first communications interface, a plurality of data values for transmission, and generating, using one or more processors, a plurality of data patterns based on the received data, each of the plurality of data patterns corresponding to one of a plurality of orbital angular momentum (OAM) topological charges of an acoustic signal transmitted from a transducer array. The methods may also include generating, using one or more processors, a transmission signal based on a combination of the plurality of data patterns, and transmitting, using the transducer array, the acoustic signal based, at least in part, on the transmission signal.

### CROSS-REFERENCE TO RELATED APPLICATIONS

This application claims the benefit under 35 U.S.C. § 119(e) of U.S. Provisional Patent Application No. 62/513,750, filed on Jun. 1, 2017, which is incorporated herein by reference in its entirety for all purposes.

### STATEMENT OF GOVERNMENT SUPPORT

This invention was made with government support under Contract No. DE-AC02-05CH11231 awarded by the U.S. Department of Energy. The government has certain rights in this invention.

### TECHNICAL FIELD

This disclosure relates generally to acoustic transmission, and more particularly to high throughput acoustic communication.

### BACKGROUND

Communication techniques for wireless transmission may utilize various forms of energy at various different wavelengths. For example, some techniques utilize light to transmit and receive signals, while other techniques may utilize sound. Accordingly, different carrier frequencies may be utilized depending on the type of transmission technique that is implemented. More specifically, optical transmission techniques may utilize higher carrier frequencies than acoustic techniques. However, in some applications, such as those underwater, such techniques remain limited. For example, optical techniques experience large amounts of scattering and are not able to propagate signals very far. Moreover, some acoustic techniques utilize a limited range of carrier frequency that is relatively slow and may be limited in its ability to transmit data.

### SUMMARY

Disclosed herein are methods, systems, and devices for acoustic transmission and reception. Methods may include receiving, at a first communications interface, a plurality of data values for transmission, and generating, using one or more processors, a plurality of data patterns based on the received data, each of the plurality of data patterns corresponding to one of a plurality of orbital angular momentum (OAM) topological charges of an acoustic signal transmitted from a transducer array. The methods may also include generating, using one or more processors, a transmission signal based on a combination of the plurality of data patterns, and transmitting, using the transducer array, the acoustic signal based, at least in part, on the transmission signal.

In various embodiments, the methods may further comprise receiving the acoustic signal at a receiver array, decoding the acoustic signal to identify the plurality of data patterns, and generating an output signal based on the decoded plurality of data patterns. In various embodiments, the methods may also include providing the output to a computer system via a second communications interface. In some embodiments, the acoustic signal is decoded based on an inner product of the plurality of OAM topological charges. In various embodiments, each of the plurality of OAM topological charges are orthogonal to each other. In some embodiments, the methods may further include chunking the received data based on a number of available OAM topological charges. In various embodiments, the transmission signal is generated based on a superposition of the plurality of data patterns.

Also disclosed herein are systems that may include a modulator configured to generate a high throughput acoustic signal. The modulator may include a transducer array configured to transmit, based on a transmission signal, an acoustic signal having a plurality of OAM topological charges and one or more processors. The one or more processors may be configured to receive a plurality of data values for transmission, and generate a plurality of data patterns based on the received data, each of the plurality of data patterns corresponding to one of the plurality of OAM topological charges. The one or more processors may also be configured to generate the transmission signal based on a combination of the plurality of data patterns. The systems may also include a receiver configured to receive a high throughput acoustic signal. The receiver may include a receiver array configured to receive the acoustic signal having the plurality of OAM topological charges, and one or more processors configured to decode the acoustic signal to identify the plurality of data patterns, generate an output signal based on the decoded plurality of data patterns.

In various embodiments, the plurality of OAM topological charges are orthogonal to each other. In some embodiments, the plurality of data patterns are generated, at least in part, by chunking the received data based on a number of available OAM topological charges. In various embodiments, the transmission signal is generated based on a superposition of the plurality of data patterns. According to various embodiments, the acoustic signal is decoded based on an inner product of the plurality of OAM topological charges. In some embodiments, the transducer array comprises an array of speakers configured based on a size of the receiver array and a distance between the receiver array and the transducer array. In various embodiments, the receiver array comprises an array of microphones. In some embodiments, the plurality of data patterns comprises eight data patterns, and wherein the eight data patterns are transmitted in parallel. In various embodiments, each of the eight data patterns corresponds to one of eight OAM topological charges.

Further disclosed herein are devices that may include a transducer array configured to transmit an acoustic signal having a plurality of OAM topological charges based on a transmission signal, and a communications interface configured to receive a plurality of data values for transmission. The devices may further include one or more processors configured to generate a plurality of data patterns based on the received data, each of the plurality of data patterns corresponding to one of the plurality of OAM topological charges, and generate the transmission signal based on a combination of the plurality of data patterns.

In various embodiments, the plurality of OAM topological charges are orthogonal to each other. In some embodiments, the plurality of data patterns are generated, at least in part, by chunking the received data based on a number of available OAM topological charges. In various embodiments, the transmission signal is generated based on a superposition of the plurality of data patterns.

Details of one or more embodiments of the subject matter described in this specification are set forth in the accompanying drawings and the description below. Other features, aspects, and advantages will become apparent from the description, the drawings, and the claims.

### BRIEF DESCRIPTION OF THE DRAWINGS

FIG. 1 illustrates an example of a system for high throughput acoustic transmission and reception, configured in accordance with some embodiments.

FIG. 2 illustrates an example of a transducer array that may be used for transmission, configured in accordance with some embodiments.

FIG. 3 illustrates flow chart of an example of transmission method, implemented in accordance with some embodiments.

FIG. 4 illustrates a flow chart of an example of another transmission method, implemented in accordance with some embodiments.

FIG. 5 illustrates a flow chart of an example of a reception method, implemented in accordance with some embodiments.

FIG. 6 illustrates a computer system configured in accordance with some embodiments.

### DETAILED DESCRIPTION

In the following description, numerous specific details are set forth in order to provide a thorough understanding of the presented concepts. The presented concepts may be practiced without some or all of these specific details. In other instances, well known process operations have not been described in detail so as to not unnecessarily obscure the described concepts. While some concepts will be described in conjunction with the specific examples, it will be understood that these examples are not intended to be limiting.

Communications techniques that are based on microwaves are limited and are infeasible for various operational conditions, such as underwater applications due to the strong absorption in ambient media, such as water. In such instances, microwave modalities have very limited transmission ranges due to such absorption. Furthermore, optical techniques are similarly limited due to scattering of light from micro-particles, and also have limited transmission ranges. Accordingly, neither technique is suitable for long range underwater communication. Moreover, existing acoustic techniques have low frequency bandwidth constraints that are defined by the relatively slower frequencies of radio waves. Such constraints limit the rate of data transmission in such existing techniques, and also make them unsuitable for transferring large amounts of data over a long range underwater as transmission of such data would take too long and be impractical in an operational environment in which a connection might not be available for that long.

Various embodiments disclosed herein utilize the orbital angular momentum (OAM) of acoustic vortex beams to provide an additional degree of freedom to transmitters. As will be discussed in greater detail below, data that is to be transmitted may be chunked and included in different data patterns sent, in parallel, on different OAM topological charges. In this way, multiple data streams may be sent in parallel, and bandwidth efficiency of the data transmission is greatly increased. Accordingly, bandwidth of long range underwater communications is greatly increased to provide high throughput communications in underwater applications including data collection and remote control of off-shore benthic stations.

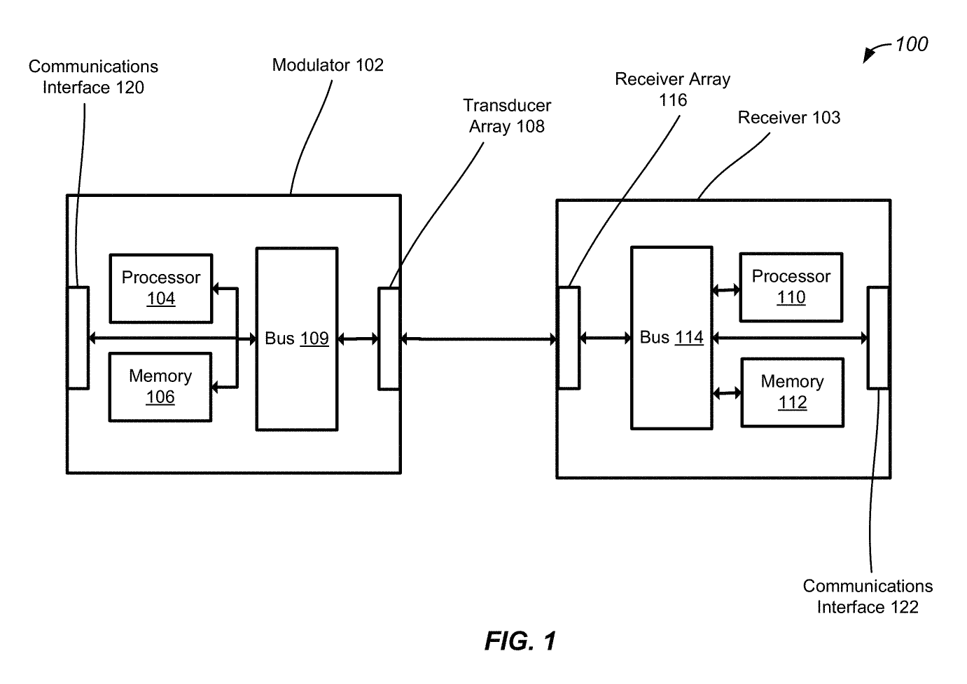

FIG. 1 illustrates an example of a system for high throughput acoustic transmission and reception, configured in accordance with some embodiments. As will be discussed in greater detail below, a system, such as system 100, may include a modulator and a receiver that may be configured to implement high throughput transmission of data in various environmental operational conditions, such as underwater applications. As discussed above, in such applications, acoustic transmission techniques may be most suitable. Accordingly, the modulator may generate and transmit a high throughput acoustic vortex beam that is sent to and received at the receiver. As will be discussed in greater detail below, features of the modulator and receiver may be specifically configured to implement such high throughput capabilities.

In various embodiments, system 100 may include a modulator, such as modulator 102. According to some embodiments, modulator 102 may be configured to generate and transmit a beam for data transmission. As will be discussed in greater detail below, the beam may be an acoustic vortex beam that is configured for high throughput transmission of data through various media, such as water. Accordingly, modulator 102 may generate a beam capable of transmitting data to a receiver, such as receiver 103, in various underwater applications, such as ocean geology, marine life studies, and off-shore oil and resource industries.

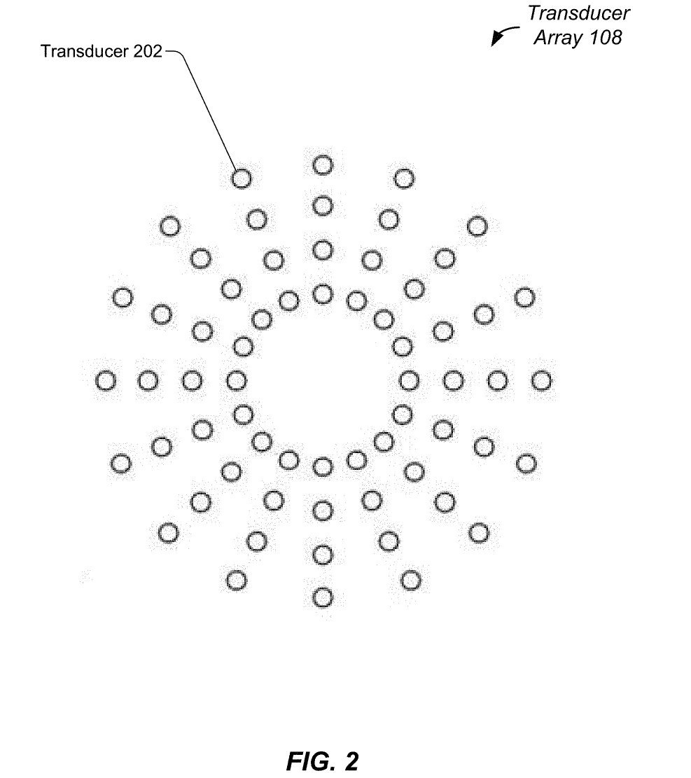

In various embodiments, modulator 102 may include a transducer array, such as transducer array 108. In various embodiments, transducer array 108 may be configured to convert a data pattern encoded in an electrical signal into an acoustic vortex beam. Accordingly, as discussed in greater detail below with reference to FIG. 2, transducer array 108 may include an arrangement or array of multiple speakers. In a specific example, such speakers may be configured to transmit sound at a specified frequency range, and the speakers may be arranged in a concentric pattern configured to generate the acoustic vortex beam. Moreover, transducer array 108 may be configured to focus the beam to achieve a particular size or diameter of the beam at a designated distance. In this way, the arrangement of the speakers within transducer array 108 may be configured to focus the beam to accommodate a particular size of a receiver, as will be discussed in greater detail below.

While a particular example, of transducer array 108 has been discussed that utilizes a particular active array, various embodiments disclosed herein may utilize other types of active arrays that may have other arrangements of active elements. In some embodiments, modulator 102 may include passive arrays. For example, transducer array 108 may instead be a passive phase array that may include a metal surface configured to transmit the beam for data transmission.

Modulator 102 may also include various components which may be configured to generate the signal transmitted by transducer array 108. For example, modulator 102 may include processor 104, memory 106, and bus 109. As will be discussed in greater detail below, processor 104 may be configured to generate different bit streams based on received data for transmission which may be received via communications interface 120. Processor 104 may be further configured to combine the bit streams or data patterns into a single signal for transmission, and provide the signal to transducer array 108 for transmission. As will be discussed in greater detail below, processor 104 may be configured to utilize different topological charges of the OAM of the transmitted beam to multiplex the bit streams for transmission in a single beam. When configured in this way, the amount of data that transducer array 108 is able to transmit is greatly increased. In various embodiments, processor 104 may be implemented within modulator 102 as an on-board logic device that includes one or more processors configured to communicate with an on-board memory device, such as memory 106. Accordingly, modulator 102 is specifically configured to implement the high-throughput transmission disclosed herein.

In various embodiments, system 100 may further include receiver 103 which may be configured to receive and decode the beam sent from modulator 102. Accordingly, receiver 103 may include receiver array 116 which may be configured to receive the beam sent from modulator 102, and convert the beam to an electrical signal. In some embodiments, receiver array 116 may include one or more microphones. Accordingly, such microphones may convert the acoustic beam into an electrical signal, and the electrical signal may be provided to other components of receiver 103.

In various embodiments, receiver 103 may include components that are configured to reconstruct the signal that was originally encoded by modulator 102. More specifically, receiver 103 may include processor 110, memory 112, and bus 114. As will be discussed in greater detail below, processor 110 may be configured to extract the bit streams from the received beam, and reconstruct the original data from the extracted bit streams. More specifically, processor 110 may be configured to take the inner product of the received signal to regenerate the bit streams and reconstruct the data that was originally sent. The reconstructed signal may be provided as an output to another system component via communications interface 122. When configured in this way, the amount of data that receiver array 116 is able to receive is greatly increased, and the overall throughput of system 100 is greatly increased. In various embodiments, processor 110 is implemented within receiver 103 as an on-board logic device that includes one or more processors configured to communicate with an on-board memory device, such as memory 112. Accordingly, receiver 103 is specifically configured to implement the high-throughput reception disclosed herein.

FIG. 2 illustrates an example of a transducer array that may be used for transmission, configured in accordance with some embodiments. As discussed above with reference to FIG. 1, modulator 102 may include a transducer array, such as transducer array 108, which may be configured to transmit an acoustic vortex beam. Accordingly, transducer array 108 may include several transducers arranged in an array specifically configured to transmit the high throughput acoustic beam generated by modulator 102, and the transducers may be configured to focus the beam to a particular size at a particular distance which may be determined based on one or more characteristics of receiver 103. As shown in FIG. 2, transducers, such as transducer 202, may be arranged in a concentric circular pattern, and such transducers may be microphones configured to transmit acoustic energy at a designated frequency.

While FIG. 2 illustrates one example, of transducer array 108, various other configurations and embodiments of transducer array 108 are contemplated and disclosed herein. For example, a different number of transducers and a different arrangement and geometry of transducer array 108 may also be implemented. Moreover, as discussed above, transducer array 108 may instead be a passive structure. For example, such passive structures may be passive phase arrays, or may be passive strictures that include spiral slits, helical surfaces, or metamaterials including phase modulation elements. Accordingly, OAM topological charges may be generated by acoustic plane waves passing through such passive devices.

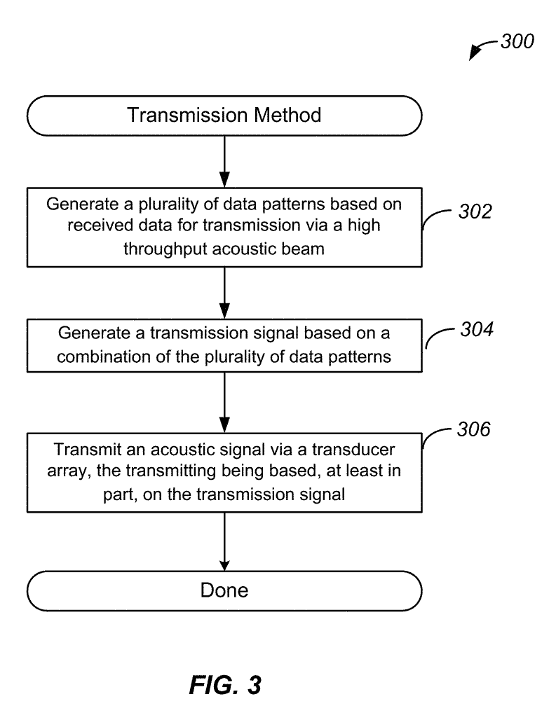

FIG. 3 illustrates flow chart of an example of transmission method, implemented in accordance with some embodiments. As discussed above, a modulator may be used to generate and transmit a high throughput acoustic beam. In various embodiments, such a beam may be generated and configured based on available OAM topological charges. As will be discussed in greater detail below, a modulator and its associated transducer array may be configured to transmit several data patterns in parallel by utilizing different OAM topological charges. Such parallel transmission of data patterns may be implemented to achieve high data throughput while maintaining integrity of the data itself.

Method 300 may commence with operation 302 during which a plurality of data patterns may be generated based on received data. In various embodiments, the received data may be data that is to be transmitted via a high throughput acoustic beam. Such an acoustic beam may have several OAM topological charges which, as will be discussed in greater detail below, may be configured to transmit several data patterns in parallel. Accordingly, each of the plurality of data patterns may correspond to one of a plurality of OAM topological charges of an acoustic signal transmitted from a transducer array.

Method 300 may proceed to operation 304 during which a transmission signal may be generated based on a combination of the plurality of data patterns. Accordingly, a system component, such as a modulator, may combine the data patterns into a single signal that may be transmitted by the transducer array. As will be discussed in greater detail below, the OAM topological charges are orthogonal to each other. Accordingly, the combination of the plurality of data patterns may be implemented via a superposition of the data patterns.

Method 300 may proceed to operation 306 during which an acoustic signal may be transmitted based, at least in part, on the transmission signal. Accordingly, the transmission signal may be provided to the transducer array, and the transducer array may convert it to an acoustic vortex beam that is transmitted to a receiver, as will be discussed in greater detail below. In this way, a transducer array and its associated acoustic beam may be configured to transmit several bits of data in parallel, and may be configured to implement high throughput acoustic transmission of data.

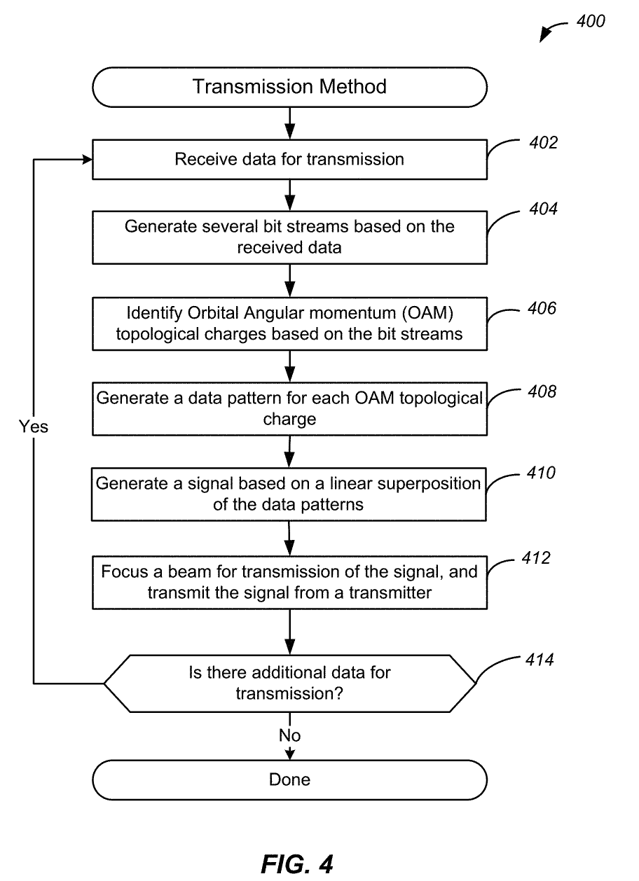

FIG. 4 illustrates a flow chart of an example of another transmission method, implemented in accordance with some embodiments. As similarly discussed above, a modulator may be used to generate and transmit a high throughput acoustic beam that may be generated and configured based on available OAM topological charges. As will be discussed in greater detail below, received data may be chunked based on a number of available OAM topological charges, and a data pattern may be generated for each available OAM topological charges. The different data patterns may be combined into a single signal, and that signal may be used for data transmission. In this way, the signal that is transmitted effectively transmits the data patterns in parallel.

Method 400 may commence with operation 402 during which data may be received for transmission. In various embodiments, the data may be received at a modulator via a communications interface, and may be received from another system component such as a computer system. Accordingly, the data may include several data values which may be included in a data file or a data stream.

Method 400 may proceed to operation 404 during which several bit streams may be generated based on the received data. Accordingly, the modulator may generate several bit streams based on the received data. In some embodiments, the modulator may determine a number of bit streams to be generated based on an available number of OAM topological charges. In some embodiments, a single OAM topological charge may be used to represent a single bit of data. Accordingly, multiple OAM topological charges may be used to represent multiple bits that are transmitted in parallel. In various embodiments, the available number of OAM topological charges may be determined based on one or more characteristics of the transducer array that is used for transmission. For example, a transducer array that includes 64 transducer elements may be configured to support eight OAM topological charges and a stream of data eight bits wide. While one example has been described with eight bits of data, any suitable number may be implemented. The modulator may generate the determined number of bit streams by chunking the received transmission data. For example, the modulator may chunk the received data into eight different bit streams.

Method 400 may proceed to operation 406 during which OAM topological charges may be identified based on the bit streams. As discussed above, several bit streams may have been generated based on the number of available OAM topological charges. During operation 406, particular bit streams may be assigned to particular OAM topological charges. In various embodiments, the OAM topological charges may be bases of the vortex beam that are orthogonal to each other. Ensuring that they are orthogonal facilitates their subsequent combination and parallel transmission, as will be discussed in greater detail below. Accordingly, during operation 406, available orthogonal OAM topological charges may be identified and assigned bit streams.

Method 400 may proceed to operation 408 during which a data pattern may be generated for each OAM topological charge. In various embodiments, a data pattern may configure a transducer array to generate an acoustic vortex beam having a particular phase, amplitude, and topological charge. Moreover, such data patterns may be configured to convey data using a suitable transmission technique, such as carrier frequency modulation. Accordingly, each data pattern may configure a particular topological charge of the vortex beam to represent the data characterized by a bit stream, as discussed above. In various embodiments, a data pattern may be generated for each OAM topological charge that will be used for transmission. In various embodiments, as discussed above, such data patterns may also be generated for transmission through one or more passive devices used to generate the OAM topological charges.

Method 400 may proceed to operation 410 during which a signal may be generated based on a superposition of the data patterns. Accordingly, the modulator may take the generated data patterns and superimpose them to generate a single data signal that may be provided to the transducer array for transmission. In various embodiments, the superimposing of the data patterns includes taking the linear superposition of the different data patterns. In various embodiments, the orthogonal nature of the OAM topological charges enables the different data patterns to be combined in this way. In various embodiments, the superposition of the data patterns may be implemented by combining all vortex beams with different OAM topological charges. In this example, such combining may be implemented using an acoustic beam splitter or one or more spin-orbital coupling devices.

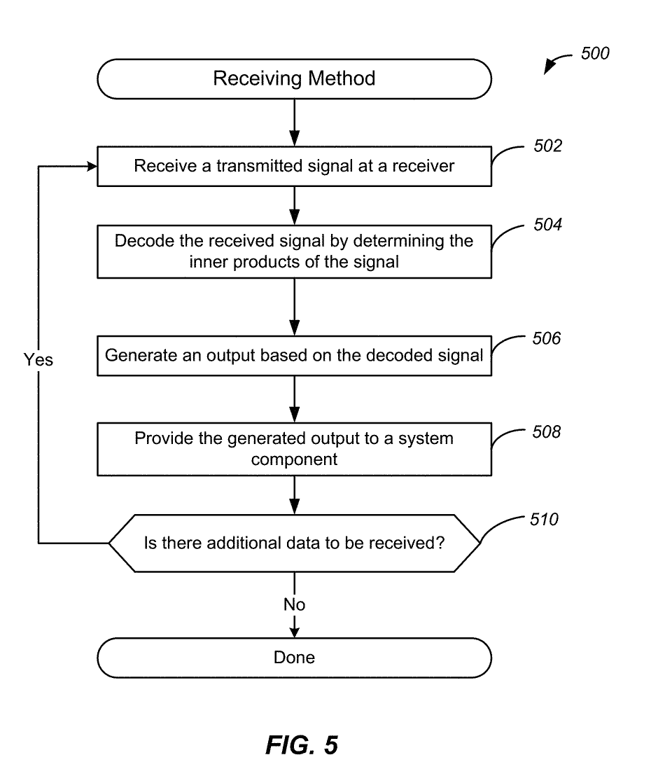

Method 400 may proceed to operation 412 during which a beam for transmission of the signal may be focused, and the signal may be transmitted from a transmitter. Accordingly, in some embodiments, transducer array 108 may be configured to focus the transmitted beam according to a designated size and distance, as similarly discussed above. Moreover, the signal generated during operation 410 may be transmitted to another system component, such as a receiver which will be discussed in greater detail below with reference to FIG. 5.

Method 400 may proceed to operation 414 during which it may be determined whether or not there is additional data. In various embodiments, such a determination may be made based on an input received from another system component, or based on one or more data values stored in memory. For example, if additional data values remain from transmission and are stored in memory, as may be the case if a file is being chunked and transmitted, then it may be determined that additional data should be transmitted. If it is determined that additional data should be transmitted, method 400 may return to operation 402. If it is determined that additional data should not be transmitted, method 400 may terminate.

FIG. 5 illustrates a flow chart of an example of a reception method, implemented in accordance with some embodiments. As discussed above, a high throughput acoustic beam may be generated and transmitted from a modulator and its associated transducer array. In various embodiments, the beam may be received at a receiver which may be configured to extract the data patterns from the single acoustic beam, and reconstruct the data that was transmitted. In this way, the transmitted data may be retrieved from the acoustic beam, and high throughput data transmission may be implemented.

Method 500 may commence with operation 502 during which a transmitted signal may be received at a receiver. As discussed above, a signal may be transmitted from a modulator, and such a signal may include multiple bit streams that have been transmitted in parallel. In various embodiments, such a beam may be received at a receiver. As discussed above, such a receiver may include a receiver array that is configured to receive acoustic signals. Accordingly, the receiver array may receive the acoustic signal, convert it to an electrical signal and provide that electrical signal to one or more other components of the receiver.

Method 500 may proceed to operation 504 during which the received signal may be decoded by determining the inner products of the signal. Accordingly, the modulator may take the inner product of corresponding bases of the received signal. In various embodiments, the inner product may be implemented based on a measured pressure field of the received signal that includes an information pattern, and the pressure field of the corresponding bases for decoding. Accordingly, the inner product may be implemented by multiplying the complex conjugate of the bases pressure with the pressure field of the received signal for each pixel of the receiver array and taking the integration of all these multiplied values. In this way, the bit information of the received signal may be decoded.

Method 500 may proceed to operation 506 during which an output may be generated based on the decoded signal. In various embodiments, the output may be a signal that characterizes the data values that were originally transmitted. Accordingly, the bit streams represented by the data patterns that are retrieved via the decoding may be reassembled by reversing the chunking that was implemented during the transmission process. In this way, the different bit streams may be reassembled into a single set of data that is the same as the data that was originally received for transmission. In various embodiments, the output that is generated may have a format compatible with another downstream system component, such as a particular computer system. Accordingly, the output may be a signal that is capable of conveying the received data values to a computer system.

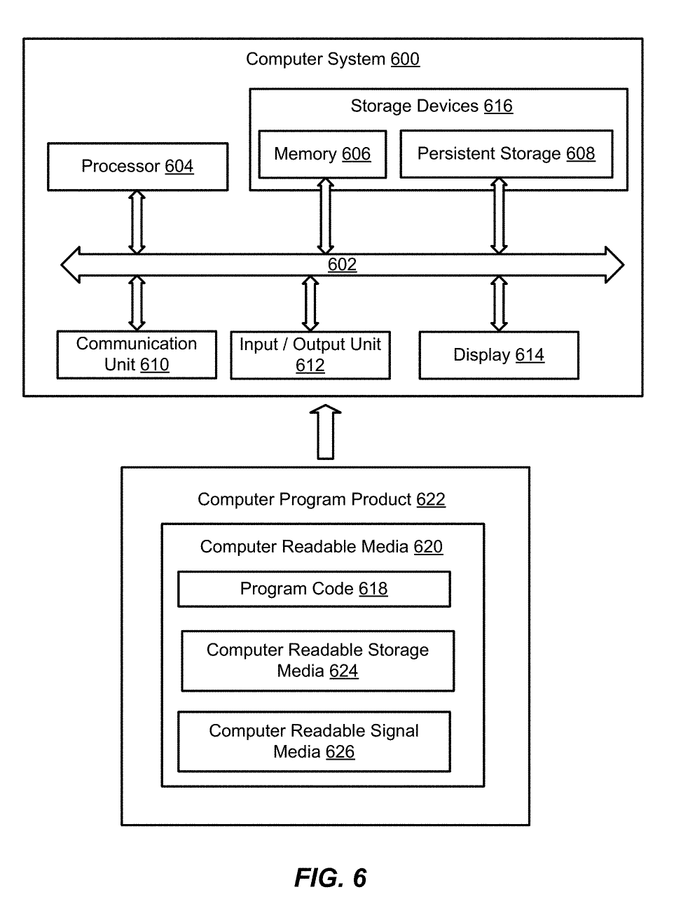

Method 500 may proceed to operation 508 during which the generated output may be provided to a system component. Accordingly, the generated output may be provided to another system component, such as a computer system described in greater detail below with reference to FIG. 6, for subsequent utilization. In this way, the data may be transmitted between system components and wirelessly through a medium, such as water, at a high throughput.

Method 500 may proceed to operation 510 during which it may be determined if there is additional data to be received. In various embodiments, such a determination may be made based on one or more of the received data values, or based on a status of a state machine implemented in the receiver. If it is determined that additional data should be received, method 500 may return to operation 502. If it is determined that additional data should not be received, method 500 may terminate.

FIG. 6 illustrates a computer system configured in accordance with some embodiments. Computer system 600 may be used to implement one or more processing devices used in conjunction with a system, such as system 100 described above. For example, computer system 600 may be coupled to either modulator 102 or receiver 103 via communications interfaces 120 and 122 respectively. In some embodiments, processor 104 and/or processor 110 may be implemented as computer systems, such as computer system 600 to off-load computational overhead from components such as modulator 102 and receiver 103. In some embodiments, computer system 600 includes communications framework 602, which provides communications between processor unit 604, memory 606, persistent storage 608, communications unit 610, input/output (I/O) unit 612, and display 614. In this example, communications framework 602 may take the form of a bus system.

Processor unit 604 serves to execute instructions for software that may be loaded into memory 606. Processor unit 604 may be a number of processors, as may be included in a multi-processor core. In various embodiments, processor unit 604 is specifically configured and optimized to process large amounts of data that may be involved when transmitting and receiving, as discussed above. Thus, processor unit 604 may be an application specific processor that may be implemented as one or more application specific integrated circuits (ASICs) within a processing system. Such specific configuration of processor unit 604 may provide increased efficiency when processing the large amounts of data involved with the previously described systems, devices, and methods. Moreover, in some embodiments, processor unit 604 may be include one or more reprogrammable logic devices, such as field-programmable gate arrays (FPGAs), that may be programmed or specifically configured to optimally perform the previously described processing operations in the context of large and complex data sets.

Memory 606 and persistent storage 608 are examples of storage devices 616. A storage device is any piece of hardware that is capable of storing information, such as, for example, without limitation, data, program code in functional form, and/or other suitable information either on a temporary basis and/or a permanent basis. Storage devices 616 may also be referred to as computer readable storage devices in these illustrative examples. Memory 606, in these examples, may be, for example, a random access memory or any other suitable volatile or non-volatile storage device. Persistent storage 608 may take various forms, depending on the particular implementation. For example, persistent storage 608 may contain one or more components or devices. For example, persistent storage 608 may be a hard drive, a flash memory, a rewritable optical disk, a rewritable magnetic tape, or some combination of the above. The media used by persistent storage 608 also may be removable. For example, a removable hard drive may be used for persistent storage 608.

Communications unit 610, in these illustrative examples, provides for communications with other computer systems or devices. In these illustrative examples, communications unit 610 is a network interface card.

Input/output unit 612 allows for input and output of data with other devices that may be connected to computer system 600. For example, input/output unit 612 may provide a connection for user input through a keyboard, a mouse, and/or some other suitable input device. Further, input/output unit 612 may send output to a printer. Display 614 provides a mechanism to display information to a user.

Instructions for the operating system, applications, and/or programs may be located in storage devices 616, which are in communication with processor unit 604 through communications framework 602. The processes of the different embodiments may be performed by processor unit 604 using computer-implemented instructions, which may be located in a memory, such as memory 606.

These instructions are referred to as program code, computer usable program code, or computer readable program code that may be read and executed by a processor in processor unit 604. The program code in the different embodiments may be embodied on different physical or computer readable storage media, such as memory 606 or persistent storage 608.

Program code 618 is located in a functional form on computer readable media 620 that is selectively removable and may be loaded onto or transferred to computer system 600 for execution by processor unit 604. Program code 618 and computer readable media 620 form computer program product 622 in these illustrative examples. In one example, computer readable media 620 may be computer readable storage media 624 or computer readable signal media 626.

In these illustrative examples, computer readable storage media 624 is a physical or tangible storage device used to store program code 618 rather than a medium that propagates or transmits program code 618.

Alternatively, program code 618 may be transferred to computer system 600 using computer readable signal media 626. Computer readable signal media 626 may be, for example, a propagated data signal containing program code 618. For example, computer readable signal media 626 may be an electromagnetic signal, an optical signal, and/or any other suitable type of signal. These signals may be transmitted over communications links, such as wireless communications links, optical fiber cable, coaxial cable, a wire, and/or any other suitable type of communications link.

The different components illustrated for computer system 600 are not meant to provide architectural limitations to the manner in which different embodiments may be implemented. The different illustrative embodiments may be implemented in a computer system including components in addition to and/or in place of those illustrated for computer system 600. Other components shown in FIG. 6 can be varied from the illustrative examples shown. The different embodiments may be implemented using any hardware device or system capable of running program code 618.

Although the foregoing concepts have been described in some detail for purposes of clarity of understanding, it will be apparent that certain changes and modifications may be practiced within the scope of the appended claims. It should be noted that there are many alternative ways of implementing the processes, systems, and apparatus. Accordingly, the present examples are to be considered as illustrative and not restrictive.

What is claimed is:

1. A method comprising:
receiving, at a first communications interface, a plurality of data values for transmission;
generating, using one or more processors of a modulator, a plurality of data patterns based on the received data, each of the plurality of data patterns corresponding to one of a plurality of orbital angular momentum (OAM) topological charges of an acoustic signal transmitted from a transducer array;
generating, using the one or more processors of the modulator, a transmission signal based on a combination of the plurality of data patterns; and
transmitting, using the transducer array, the acoustic signal based, at least in part, on the transmission signal, the transmitting of the acoustic signal comprising generating an acoustic vortex beam based on the acoustic signal.

2. The method of claim 1 further comprising:
receiving the acoustic signal at a receiver array;
decoding the acoustic signal to identify the plurality of data patterns; and
generating an output signal based on the decoded plurality of data patterns.

3. The method of claim 2 further comprising:
providing the output to a computer system via a second communications interface.

4. The method of claim 2, wherein the acoustic signal is decoded based on an inner product of the plurality of OAM topological charges.

5. The method of claim 1, wherein the plurality of OAM topological charges are orthogonal to each other.

6. The method of claim 1 further comprising:
chunking the received data based on a number of available OAM topological charges.

7. The method of claim 1, wherein the transmission signal is generated based on a superposition of the plurality of data patterns.

8. A system comprising:
a modulator configured to generate a high throughput acoustic signal, the modulator comprising:
a transducer array configured to transmit, based on a transmission signal, an acoustic signal having a plurality of OAM topological charges; and
one or more processors configured to:
receive a plurality of data values for transmission;
generate a plurality of data patterns based on the received data, each of the plurality of data patterns corresponding to one of the plurality of OAM topological charges;
generate the transmission signal based on a combination of the plurality of data patterns; and
a receiver configured to receive a high throughput acoustic signal, the receiver comprising:
a receiver array configured to receive the acoustic signal having the plurality of OAM topological charges; and
one or more processors configured to:
decode the acoustic signal to identify the plurality of data patterns; and
generate an output signal based on the decoded plurality data. patterns.

9. The system of claim 8, wherein the plurality of OAM topological charges are orthogonal to each other.

10. The system of claim 8, wherein the plurality of data patterns are generated, at least in part, by chunking the received data based on a number of available OAM topological charges.

11. The system of claim 8, wherein the transmission signal is generated based on a superposition of the plurality of data patterns.

12. The system of claim 8, wherein the acoustic signal is decoded based on an inner product of the plurality of OAM topological charges.

13. The system of claim 8, wherein the transducer array comprises an array of speakers configured based on a size of the receiver array and a distance between the receiver array and the transducer array.

14. The system of claim 13, wherein the receiver array comprises an array of microphones.

15. The system of claim 8, wherein the plurality of data patterns comprises eight data patterns, and wherein the eight data patterns are transmitted in parallel.

16. The system of claim 15, wherein each of the eight data patterns corresponds to one of eight OAM topological charges.

17. A device comprising:
a transducer array configured to transmit an acoustic signal having a plurality of orbital angular momentum (OAM) topological charges based on a transmission signal;
a communications interface configured to receive a plurality of data values for transmission; and
one or more processors configured to:
generate a plurality of data patterns based on the received data, each of the plurality of data patterns corresponding to one of the plurality of OAM topological charges; and
generate the transmission signal based on a combination of the plurality of data patterns.

18. The device of claim 17, wherein the plurality of OAM topological charges are orthogonal to each other.

19. The device of claim 17, wherein the plurality of data patterns are generated, at least in part, by chunking the received data based on a number of available OAM topological charges.

20. The device of claim 17, wherein the transmission signal is generated based on a superposition of the plurality of data patterns.
